(19) United States
(12) Patent Application Publication
(10) Pub. No.: US 2023/0335970 A1
(43) Pub. Date: Oct. 19, 2023

(54) SYSTEMS AND METHODS FOR HIGH ENERGY-EFFICIENT COHERENT RAMAN SPECTROSCOPY WITH A DUAL-COMB LASER

(71) Applicant: BAYSPEC, INC., San Jose,, CA (US)

(72) Inventors: Kotaro HIRAMATSU, Kanagawa (JP); Risako KAMEYAMA, Kanagawa (JP); Keisuke GODA, Kanagawa (JP)

(21) Appl. No.: 18/041,947

(22) PCT Filed: Aug. 27, 2021
(86) PCT No.: PCT/US2021/048006

§ 371 Date: Feb. 16, 2023

Related U.S. Application Data
(60) Provisional application No. 63/071,377, filed on Aug. 28, 2020.

(30) Foreign Application Priority Data
Sep. 11, 2020 (JP) 2020-153374

(51) Int. Cl. H01S 3/139; H01S 3/10

(52) U.S. Cl. CPC H01S 3/1394; H01S 3/10046; G01N 21/65

(57) ABSTRACT

Systems and methods for operating a dual-comb laser. The methods comprise: generating pulsed laser beams by first and second laser sources of the dual-comb laser, at least one of the first and second laser sources comprises a diode pumped solid state laser with an output intensity that is modifiable; and matching phase repetition rates of the pulsed laser beams by selectively modifying the output intensity of the diode pumped solid state laser.

### CROSS-REFERENCE TO RELATED APPLICATIONS

The present application claims priority to U.S. Provisional Patent Application No. 63/071,388 which was filed on Aug. 28, 2020 and Japanese Patent Application No. 2020-153374 filed on Sep. 11, 2020. The contents of which are incorporated herein by reference in their entirety.

### BACKGROUND

### Statement of the Technical Field

The present document concerns spectroscopic measurement systems. More specifically, the present document concerns systems and methods for high energy-efficient coherent Raman spectroscopy with a dual-comb laser.

### Description of the Related Art

The recent advent of high-speed vibrational spectroscopy and imaging tools has fueled discoveries in biomedical and material sciences. These tools are based on coherent Raman scattering processes (e.g., Stimulated Raman Scattering (SRS) and Coherent Anti-stoked Raman Scattering (CARS)) and have been employed for diverse applications (e.g., such as cancer detection, metabolic analysis, drug discovery, flow cytometry, and polymerization analysis. Also, they are highly effective for studying fast dynamical events which are difficult or impossible to reproduce and are, hence, inaccessible with traditional pump-probe methods. Among various types of high-speed vibrational spectroscopy methods, nonlinear dual-comb spectroscopy, or more specifically Dual Comb CARS (DC-CARS) spectroscopy, is particularly attractive as it has the unique ability to rapidly acquire high-resolution Raman spectra in the fingerprint region with a single-pixel photodetector. For example, the state-of-the-art laser technology has enabled performance as high as 200-1,400 cm⁻¹ in spectral range, 3 cm⁻¹ in spectral resolution, and ten thousand spectra per second in spectral acquisition rate. These excellent attributes of DC-CARS spectroscopy are realized based on the principle known as asynchronous optical sampling in which a pair of optical frequency combs with pulse repetition rates fixed at slightly different frequencies are employed. In this scheme, while the group delay between ultrashort pump and probe pulses is rapidly and automatically scanned without any mechanical motion due to the frequency difference between the two combs, the pump pulse excites molecular vibrations in the sample whose temporal evolution is monitored by the probe pulse as a time-domain interferogram. The Raman spectrum of the sample is then obtained by taking the Fourier transform of the time-domain interferogram measured by a single-pixel photodetector.

Unfortunately, DC-CARS spectroscopy is highly inefficient since greater than ninety nine percent of its laser energy is not used for the CARS process and is, hence, simply wasted. This is because the duty cycle of its spectral acquisition is only less than one percent due to the mismatch between the interval of the laser pulses (>1 ns) and the coherence lifetime of molecular vibrations (˜3 ps), resulting in compromised spectral acquisition rate and low Signal-to-Noise Ratio (SNR). To improve the duty cycle, the most straightforward approach is to increase the laser repetition rate by reducing the cavity length of each frequency comb laser. Although mode-locked lasers with high repetition rates of greater than one gigahertz have been developed and are commercially available, they, however, come at the expense of pulse energy since there is a trade-off between pulse repetition rate and pulse energy, making it undesirable for nonlinear optical interaction that essentially requires high pulse peak intensity. Another approach for high-speed CARS spectroscopy is Fourier Transform CARS (FT-CARS) spectroscopy in which the group delay between pump and probe pulses is rapidly scanned with a mechanical scanner, but its spectral acquisition rate is limited by the inertia of the mechanical scanner.

### SUMMARY

This document concerns systems and methods for operating a dual-comb laser. The methods comprise: generating pulsed laser beams by first and second laser sources of the dual-comb laser, at least one of the first and second laser sources comprises a diode pumped solid state laser with an output intensity that is modifiable; and matching phase repetition rates of the pulsed laser beams by selectively modifying the output intensity of the diode pumped solid state laser (e.g., by transitioning the diode pumped solid state laser from a first output intensity level to a second different output intensity level).

In some scenarios, the first laser source comprises a diode pumped solid state laser with a fixed output intensity, and the second laser source comprises the diode pumped solid state laser with the output intensity that is modifiable. The output intensity of the diode pumped solid state laser may be selectively modified based on a group-delay value determined using two-color interferometry and/or by changing an electrical current supplied to the diode pumped solid state laser. The electrical current may be changed responsive to the group-delay value. The selective modification of the output intensity of the diode pumped solid state laser causes a refractive index of a crystal to be changed, whereby the pulse repetition rates are matched.

In those or other scenarios, the methods also comprise: generating a feedback signal using one of the pulsed laser beams; using the feedback signal to control a position of mirror in a laser cavity of the first or second laser sources which is driven by a piezoelectric transducer; and/or rapidly modulating a difference between the phase repetition rates of the first and second laser sources.

This document also concerns systems and methods for operating a laser source. The methods comprise: generating a pulsed laser beam using a crystal pumped by an exciting laser beam output from a diode pumped solid state laser; and selectively changing an intensity of the exciting laser beam to cause a refractive index of the crystal to change. The intensity of the exciting laser beam may be selectively changed based on a group-delay value determined using two-color interferometry and/or by adjusting an electrical current supplied to the diode pumped solid state laser (e.g., on a group-delay value determined using two-color interferometry).

This document further concerns dual-comb lasers. Each dual-comb laser comprises first and second laser sources configured to generate pulsed laser beams. At least one of the first and second laser sources comprises a diode pumped solid state laser with an output intensity that is modifiable. The dual-comb laser also comprises a circuit configured to selectively modify the output intensity of the diode pumped solid state laser for matching phase repetition rates of the pulsed laser beams.

In some scenarios, the first laser source comprises a diode pumped solid state laser with a fixed output intensity, and the second laser source comprise the diode pumped solid state laser with the output intensity that is modifiable. The output intensity of the diode pumped solid state laser may be selectively modified: based on a group-delay value determined using two-color interferometry; by transitioning the diode pumped solid state laser from a first output intensity level to a second different output intensity level; and/or by changing an electrical current supplied to the diode pumped solid state laser. The electrical current may be changed responsive to a group-delay value determined using two-color interferometry.

The dual-comb laser further comprises a crystal having a refractive index that changes when the output intensity of the diode pumped solid state laser is modified, whereby the pulse repetition rates become matched. The circuit is further configured to (i) generate a feedback signal using one of the pulsed laser beams and (ii) use the feedback signal to control a position of mirror in a laser cavity of the first or second laser sources which is driven by a piezoelectric transducer.

This document further concerns a laser source. The laser source comprises: a diode pumped solid state laser; a crystal configured to generate a pulsed laser beam when pumped by an exciting laser beam output from the diode pumped solid state laser; and a circuit configured to selectively change an intensity of the exciting laser beam to cause a refractive index of the crystal to change. The intensity of the exciting laser beam may be selectively changed: based on a group-delay value determined using two-color interferometry; and/or by adjusting an electrical current supplied to the diode pumped solid state laser. The electrical current is adjusted based on a group-delay value determined using two-color interferometry.

### BRIEF DESCRIPTION OF THE DRAWINGS

This disclosure is facilitated by reference to the following drawing figures, in which like numerals represent like items throughout the figures.

FIGS. 1-2 provide graphs that are useful for understanding a conceptual difference between conventional DC-CARS spectroscopy and Quasi-DC-CARS spectroscopy.

FIG. 3 provides an illustration of a Quasi-DC-CARS spectroscopy apparatus.

FIG. 4 provides a block diagram for an illustrative circuit for a laser source.

FIGS. 5(a)-5(e) (collectively referred to as “FIG. 5”) provide graphs that are useful for understanding a procedure for calculating a group delay from Two-Color Interferograms (TCIs).

FIGS. 6(a)-6(d) (collectively referred to as “FIG. 6”) provide graphs that show results of an experimental demonstration of Quasi-DC-CARS spectroscopy.

FIGS. 7(a)-7(c) (collectively referred to as “FIG. 7”) provide graphs showing results of an analysis of SNR in Quasi-DC-CARS spectroscopy.

FIG. 8 provides a flow diagram of an illustrative method for Quasi-DC-CARS spectroscopy.

FIG. 9 provides a flow diagram of an illustrative method for determine group-delay measurements.

FIG. 10 provides an illustration of a computing device.

FIG. 11 provides graphs that are useful for understanding pulse repetition rate modulation by controlling an intensity of a pump laser for a crystal.

### DETAILED DESCRIPTION

It will be readily understood that the solution described herein and illustrated in the appended figures could involve a wide variety of different configurations. Thus, the following more detailed description, as represented in the figures, is not intended to limit the scope of the present disclosure but is merely representative of certain implementations in different scenarios. While the various aspects are presented in the drawings, the drawings are not necessarily drawn to scale unless specifically indicated.

Reference throughout this specification to features, advantages, or similar language does not imply that all the features and advantages that may be realized should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

The term “spectroscopy” refers to an analysis of an interaction between matter and electromagnetic radiation as a function of a wavelength or frequency of radiation. During this analysis, measurements can be taken of spectra produced when matter interacts with or emits electromagnetic radiation.

The term “Raman spectroscopy” refers to a spectroscopic technique used to determine vibrational modes of molecules. These vibrational modes provide a structural fingerprint by which the molecules can be identified. Raman spectroscopy relies upon inelastic scattering of photons, known as Raman scattering. When a laser light interacts with molecular vibrations, the energy in the laser photons is shifted up or down. The shift in energy provides information that can be used to determine the vibrational modes of molecules.

The term “dual-comb spectroscopy” refers to a spectroscopic technique that utilizes two coherent laser sources with different repetition frequencies to excite and probe a molecular sample.

The terms “Dual-Comb Coherent Anti-stokes Raman Spectroscopy” or “DC-CARS” refers to a spectroscopic technique that utilizes two coherent laser sources with different repetition frequencies to determine vibrational modes of molecules. DC-CARS allows non-invasive measurement for chemical analysis of objects. DC-CARS systems generate ultrashort laser pulses that group delay between pump pulses and probe pulses are automatically scanned by mixing a pair of laser pulses at slightly different pulse repetition rates. The laser pulses are passed to a sample to excite molecular vibration therein. Time-domain interferograms are measured. Raman spectra of the sample can be obtained by Fourier-time-domain interferogram transforming the time domain interferograms.

DC-CARS is a powerful tool for rapidly probing vibrational signatures of molecules in the fingerprint region. However, great than ninety-nine percent of its incident laser energy is unused and wasted since the duty cycle of its spectral acquisition is only less than one percent due to the mismatch between the interval of the laser pulses (>1 ns) and the coherence lifetime of molecular vibrations (˜3 ps). In this document, a one hundred percent energy-efficient DC-CRS is described with a “quasi”-dual-comb laser. The DC-CRS can provide a relatively high spectral acquisition rate of one hundred thousand spectra per second with even higher sensitivity than conventional slower DC-CRS.

The present solution comprises a one hundred percent energy-efficient DC-CARS spectroscopy with a Quasi-dual-comb laser. The concept of the present solution originates from THz time-domain spectroscopy with electronically controlled optical sampling, but it is not directly applicable to high-speed vibrational spectroscopy methods (e.g., DC-CARS spectroscopy) because its operation is relatively slow (˜1 kHz) due to the slow response of piezoelectric transducers that modulate the laser cavity length and its group delay measurement accuracy is far from what is required for high-speed vibrational spectroscopy methods. This limitation is overcome by rapidly modulating the cavity length of one of the frequency combs via modulating the Kerr lens effect in the laser gain medium (which is referred herein as a quasi-comb state) and accurately measuring the group delay between pump and probe pulses by two-color interferometry for calibrating the phase of each Raman active mode in the sample. Specifically, by scanning the group delay from 0.0 ps to 0.7 ps at a scan rate of up to one hundred thousand scans per second with a duty cycle of nearly one hundred percent, the DC-CARS spectroscopy occurs at a relatively high spectral acquisition rate of one hundred thousand spectra per second. By virtue of the high duty cycle, the detection sensitivity of the present solution is also enhanced to be greater than one hundred times higher than that of conventional DC-CARS spectroscopy with a fixed comb-frequency difference. In other words, the present solution (termed Quasi-DC-CARS spectroscopy) is great than one hundred times higher in the product of spectral acquisition rate and spectral power density than conventional DC-CARS spectroscopy. Quasi-DC-CARS spectroscopy can be used for a wide range of applications in which both high speed and high sensitivity are required for vibrational spectroscopy. Such applications include, but are not limited to, particle analysis, flow cytometry, high-throughput screening, real-time large-tissue imaging, and/or polymerization analysis.

Theory of Quasi-DC-CARS Spectroscopy

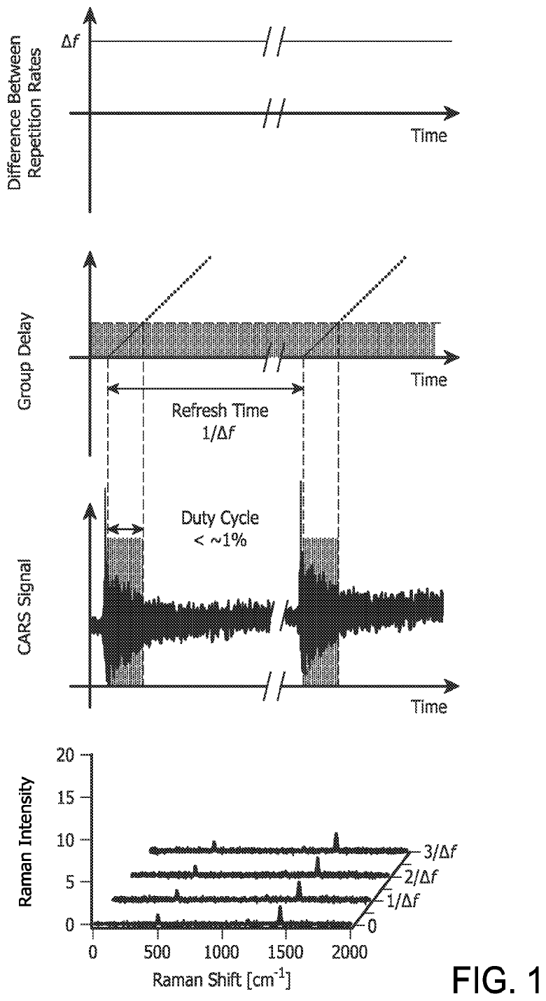

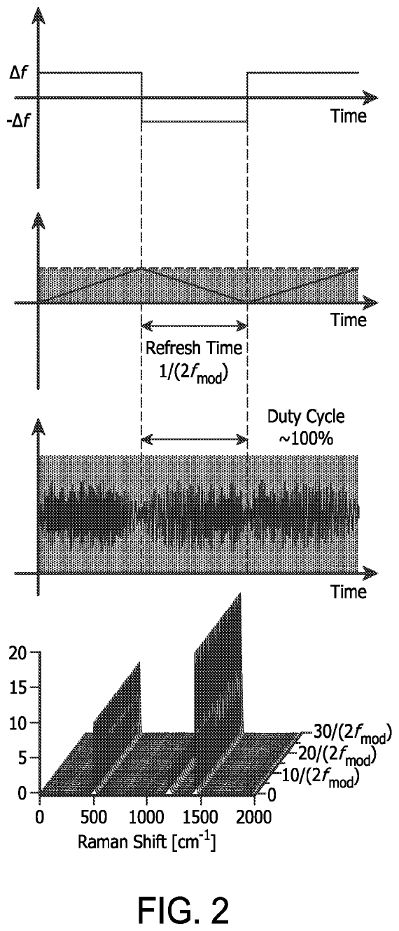

The conceptual difference between conventional DC-CARS spectroscopy and Quasi-DC-CARS spectroscopy can be understood with reference to FIGS. 1-2. As shown in FIG. 1, conventional DC-CARS spectroscopy employs a pair of frequency combs whose repetition rates are slightly different and fixed. Since the group delay between pump and probe pulses is determined as Δt=f₁⁻−f₂⁻¹, where f₁ and f₂ are the pulse repetition rates of frequency combs one and two respectively, the group delay spans from zero to 1/f₁, assuming f₁<f₂. With f₁≃f₂≃1 GHz based on the highest pulse repetition rates of commercially available lasers, the group delay exceeds the coherence lifetime of molecular vibrations (˜3 ps) during greater than ninety-nine percent of the spectral acquisition time, which results in a very low duty cycle of greater than one percent. Moreover, the spectral acquisition rate of conventional DC-CARS spectroscopy is limited by the Nyquist frequency. For covering the entire fingerprint region (200-1,600 cm⁻¹) with a one gigahertz dual-comb laser, the repetition rate difference Δf=|f₂−f₁| must be less than 10.4 kHz.

The present solution's strategy for achieving a duty cycle of nearly one hundred percent can be understood with reference to FIG. 2. By rapidly modulating the repetition rate of one of the frequency combs at a modulation frequency f_{mod} (i.e., by rapidly modulating the difference between the repetition rates of the two frequency combs), the group delay spans from zero to approximately 3 picoseconds (close to the coherence lifetime of molecular vibrations), such that virtually all the pump and probe pulses contribute to the CARS signal generation. Consequently, the spectral acquisition rate of Quasi-DC-CARS spectroscopy is determined to be a factor of two times the modulation frequency of the frequency rate difference. By virtue of the high energy efficiency, Quasi-DC-CARS spectroscopy achieves not only much higher spectral acquisition time, but also much higher sensitivity than conventional DC-CARS spectroscopy.

Illustrative Quasi-DC-CARS Spectroscopy Apparatus

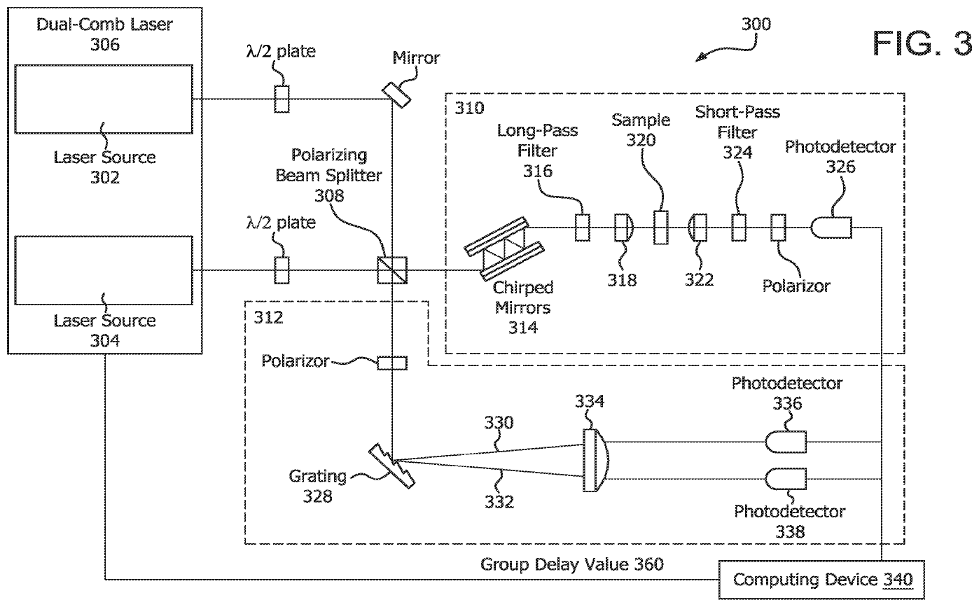

Referring now to FIG. 3, there is provided an illustration of a Quasi-DC-CARS spectroscopy apparatus 300. A pair of laser sources 302, 304 is used as a dual-comb laser source 306. The laser sources 302, 304 comprise lasers based on vibronic titanium doped sapphire crystal (Ti:Sapphire crystal). These lasers are referred to as Ti:Sapphire lasers. The Ti:Sapphire lasers can include, but are not limited to, taccor power lasers available from Cambridge Technology of Bedford Massachusetts. The Ti:Sapphire lasers operate at repetition rates of approximately one gigahertz, have outputs that are mode locked, and are capable of ultra-short pulses from a few picoseconds (ps) to tens of attoseconds (as) (e.g., tens of femtoseconds (fs)) in duration. Each Ti:Sapphire laser emits a laser beam created by pumping the Ti:Sapphire crystal with an exciting laser beam at a shorter wavelength. The exciting laser beam is generated by a Diode-Pumped Solid-State (DPSS) laser. An intensity of the DPSS laser can be rapidly controlled by adjusting a strength of an electrical current applied to the DPSS laser. Consequently, an optical path length of the Ti:Sapphire crystal can be modulated as its refractive index changes, depending on the pump power through the nonlinear optical Kerr effect The pulse repetition rate of laser source 302 can be modulated at up to f_{mod}=50 kHz.

The two laser beams output from the dual-comb laser source 306 are combined at a Polarizing Beam Splitter (PBS) 308, and caused to travel along two paths 310, 312. Path 310 is used for CARS signal measurements, while the path 312 is used for group-delay measurements by two-color interferometry.

For CARS signal measurements of path 310, the laser beam is focused onto a sample 320 via an achromatic lens 318 after chirp compensation with a pair of chirped mirrors 314. The generated CARS signal from the sample is extracted from the incident beam by an optical long-pass filter 316 provided before sample 320 and an optical short-pass filter 324 provided after the sample 320. The CARS signal is detected by a photodetector 326. Photodetector 326 can include, but is not limited to, a high sensitivity avalanche photodetector having part number APD210 which is available from Menlo Systems GmbH of Germany.

For the two-color interferometric measurements of path 312, the laser beam is spatially dispersed by a diffraction grating 328 into two laser beams 330, 332 with nearly equal intensities and different frequencies (e.g., red and blue). The laser beams 330, 332 travel through one or more achromatic lenses 334. The achromatic lens(es) 334 is(are) configured to focus the laser beams in directions towards photodetectors 336, 338. An intensity of light in laser beam 330 is detected and measured by a photodetector 336. An intensity of light in laser beam 332 is detected and measured by a photodetector 338. The measured light intensities are then provided from the photodetectors 336, 338 to a computing device 340 for storage and/or processing.

The computing device 340 uses the measured light intensities to determine a group-delay value 360. Group-delay values and techniques for determining the same based on intensity measurements are well known. The group delay value 360 is then passed from the computing device 340 to the dual-comb laser source 306 for use in selectively controlling an output intensity of a DPSS laser in one or both laser sources 302, 304. The output intensity can be selectively varied between a high intensity value and a low intensity value. For example, the DPSS is controlled to have a high intensity value when the group-delay has a value zero picoseconds, and is controlled to have a low intensity value when the group-delay has a value between a half a picosecond to a couple of picoseconds. The present solution is not limited to the particulars of this example.

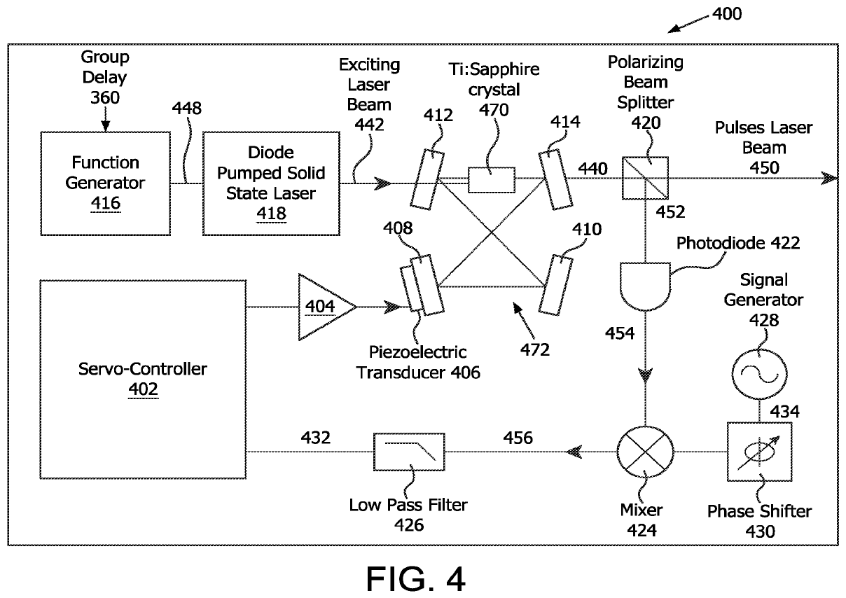

The selective variation of DPSS laser output intensity causes a refractive index of the Ti:Sapphire crystal to change relatively quickly such that the pulse repetition rate of a pulsed laser beam can be modified at least a few orders of magnitude faster as compared to that caused by adjusting a laser-cavity mirror (i.e., mirror 408 of FIG. 4) via a piezoelectric transducer (i.e., piezoelectric transducer 406 of FIG. 4). The DPSS laser output intensity is selectively varied in one or both lasers 302, 304. The position of the laser-cavity mirror may optionally be selectively varied in one or both lasers 302, 304 in addition to the selective variation of the DPSS laser output intensity.

In the present setup, with the diffraction grating 328 having a groove density of twelve thousand grooves per millimeter (mm), an achromatic lens 334 with a focal length of two hundred millimeters and a photodetector 336, 338 with an effective area of 0.126 mm², the maximum measurable group delay is estimated to be 18.7 ps. The measured CARS signals and two-color interferometry signals are electrically filtered by low-pass filters (not shown) respectively with a cutoff frequency of five hundred thirty megahertz and six hundred megahertz, and digitized by a high-speed oscilloscope (not shown) at five Giga-samples per second. The high-speed oscilloscope can include, but is not limited to, a digital oscilloscope having a part number RTOl 004 which is available from Rohde & Schwarz USA, Inc. of Columbia Maryland.

Referring now to FIG. 4, there is provided a more detailed block diagram for a laser source 400. Laser sources 302, 304 of FIG. 3 can be the same as or similar to laser source 400. As such, the discussion of laser source 400 is sufficient for understanding laser sources 302, 304 of FIG. 3. Laser source 400 comprises various electronic circuit components 402-430 configured to control a pulse repetition rate of an output pulsed laser beam 450. Operation of these components will first be described in relation to laser source 302 of FIG. 3, and then in relation to laser source 304 of FIG. 3.

The pulse repetition rate of the laser source 302 of FIG. 1 may be stabilized at a constant frequency f1 by a servo-controller 402 using feedback information. The servo-controller 402 receives a feedback signal 432 output from a feedback branch 422-426 and uses contents of the same to control the position of a laser-cavity mirror 408 which is driven by a piezoelectric transducer 406. The piezoelectric transducer 406 is provided to modulate a length of a laser cavity consisting of a set of mirrors 408, 410, 412, 414. The laser cavity 408-414 is configured to (i) force the generated light to follow a closed path and (ii) to control the frequency at which light pulses are generated by the laser source 400. This light pulse frequency is referred to herein as the pulse repetition rate. Mirror 414 also functions as an output coupler that transmits a fraction of the incident light, thereby providing a repetitive train or sequence of pulses as a pulsed light beam 440.

The pulsed laser beam 440 travels to a beam splitter 420. The beam splitter 420 comprises an optical device that splits the pulsed laser beam 440 into two pulsed laser beams 450 and 452. The pulsed laser beam 450 is output from the laser source 400. In contrast, the pulsed laser beam 452 is provided to the feedback branch 422-426.

The feedback branch 422-426 comprises a photodiode 422, a mixer 424 and a low pass filter 426. Photodiode 422 comprises a semiconductor diode which converts light of the pulsed laser beam 452 into an electrical current 454. The electrical current 454 flows to the mixer 424 where it is mixed with a waveform 434 from a signal generator 428. The signal generator 428 can include, but is not limited to, a signal generator having part number SMA 100A which is available from Rohde & Schwarz USA, Inc. of Columbia Maryland. This signal mixing is minimized by Proportional-Integral (PI) control. The signal 456 output from mixer 424 is filtered by low pass filter 426 to produce the feedback signal 432, which is used by the servo-controller 402 to stabilize the pulse repetition rate of the laser source at a constant frequency f1.

The pulse repetition rate of laser source 304 of FIG. 3 is rapidly modulated as f₂=f₁+g(t), where g(t) is a symmetric modulation function that satisfies ∫_{-∞}^{∞}g(t)dt=0. To modulate the pulse repetition rate around f₁, the position of mirror 408 is controlled in the same way as described above in relation to laser source 302. The rapid modulation g(t) is generated by (i) controlling the intensity of the DPSS laser 418 that pumps the mode-locked laser, or (ii) specifically changing the current through the driver for the pump-diode. In some scenarios, a square function generator 416 is used to generate a signal with an amplitude that is adjusted to provide a duty cycle of spectral scans close to one hundred percent.

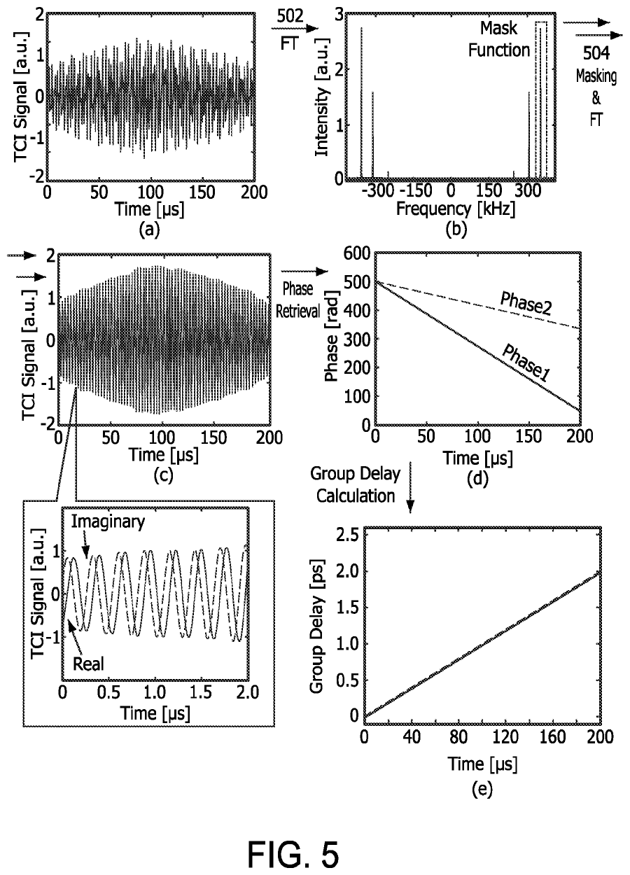

The role of the two-color interferometer is to accurately measure the group delay in conjunction with the CARS signal measurements and use the group delay to calibrate the phase of each Raman active mode in the sample 320 since the modulation g(t) does not exactly follow the input driving function due to pump intensity fluctuations in time. Specifically, according to the known procedure shown in FIG. 5, the group delay can be calculated from TCIs at wavelengths w₁ and w₂. Illustrative measured TCIs are shown in FIG. 5(a). The measured TCIs are Fourier transformed as shown by arrow 502 to provide spectra having three peaks as shown in FIG. 5(b). Next, the necessary frequency components of the spectra at around twenty-one kilohertz are extracted by applying a mask function as shown by arrow 504 to eliminate the unnecessary frequency components. Then, the masked spectra are inverse Fourier transformed to reconstruct the complex TCIs as shown in FIG. 5(c), from which the phase delays at w₁ and w₂ can be calculated as the arguments thereof as shown in FIG. 5(d). The group delay between the two pulses τ is obtained as τ=(ϕ₁−ϕ₂)/(w₁−w₂), where ϕ₁ and ϕ₂ are the phase delays at w₁ and w₂ (see FIG. 5(e)). The accuracy of the TCI-based group delay measurements was evaluated under the condition that the pulse repetition rates of the two laser sources 302, 304 were fixed at 1,000.200 MHz and 1,000.190 MHz, from which the error was found to be 17.5 fs, corresponding to an error of 0.146 cm⁻¹ in the Raman spectral domain.

Experimental Demonstration of Quasi-DC-CARS Spectroscopy

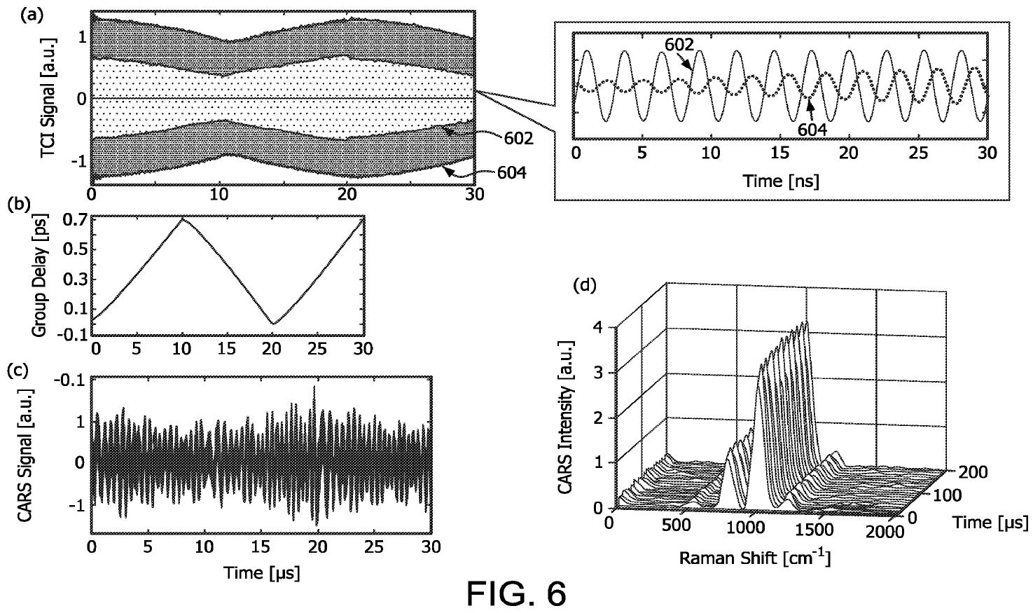

A proof-of-principle demonstration of Quasi-DC-CARS spectroscopy was performed with a modulation rate of fifty kilohertz using liquid toluene as a sample. FIG. 6(a) shows TCIs obtained at 767 and 816 nm, from which the group delay was calculated as shown in FIG. 6(b) by following the procedure discussed above in relation to FIG. 5. The CARS signal, which was simultaneously recorded with the TCIs, was accurately calibrated by using the calculated group delay shown in FIG. 5(c). The calibrated CARS signal was Fourier-transformed to obtain a series of CARS spectra shown in FIG. 5(d). The obtained CARS spectra show Raman peaks at 532, 786, 1004, and 1210 cm⁻¹. The spectral acquisition rate of the Quasi-DC-CARS spectrometer was 100,000 spectra per second, which is ten times higher than the highest reported rate of conventional DC-CARS spectroscopy and twice higher than the highest reported rate of FT-CARS spectroscopy with rapid mechanical delay scanning. At 100,000 spectra per second, the group delay scanning range was calculated to be 0.71 ps, which corresponds to a spectral resolution of 23.4 cm⁻¹. While the spectral resolution was sacrificed as it is determined by the group-delay scan range which is inversely proportional to the modulation frequency, the spectral features previously buried in noise including the Raman peaks at 532 and 1,210 cm⁻¹ are recognizable by virtue of the high energy efficiency of the Quasi-DC-CARS scheme. The spectral resolution can be improved without sacrificing the spectral acquisition rate by a recently proposed method in which the spectral resolution of Raman spectra obtained from time-domain interferograms measured in a limited temporal region can be enhanced by assuming that the interferograms are composed of multiple exponentially decaying sinusoidal functions.

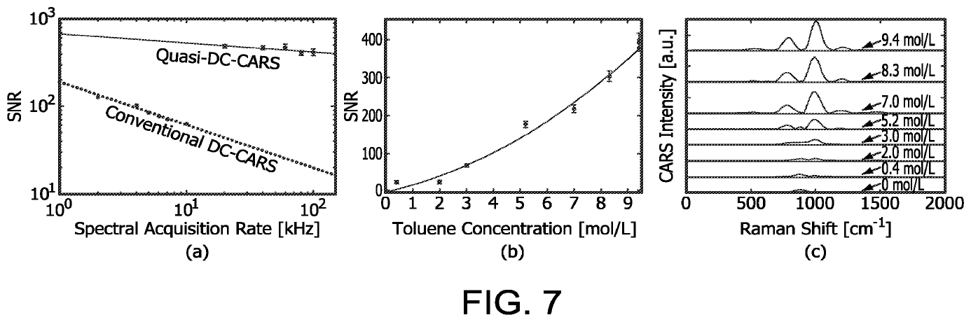

More quantitative analysis of SNR as a function of modulation frequency and sample concentration is provided as follows. The SNR of measured CARS spectra of toluene was evaluated with the peak heights at about 1,004 cm⁻¹ and the intensity standard deviation at about 1780 cm⁻¹ at various spectral acquisition rates. As shown in FIG. 7(a), based on the fitting, the SNR in conventional DC-CARS spectroscopy is proportional to (spectral acquisition rate)^{-0.489}, which is close to what is theoretically expected when the noise floor is dominated by photon shot noise. In contrast, the SNR in Quasi-DC-CARS spectroscopy is proportional to (spectral acquisition rate)^{-0.104}. This smaller slope is presumably due to different origins of noise to the conventional DC-CARS method, such as temporal fluctuation of laser intensity with the rapid modulation of a repetition rate. Specifically, based on the fits, at a spectral acquisition rate of one hundred thousand per second, the SNR in Quasi-DC-CARS spectroscopy is about twenty times higher than that in conventional DC-CARS spectroscopy (if one hundred thousand spectra per second were possible). In other words, Quasi-DC-CARS spectroscopy at one hundred thousand spectra per second achieves the same SNR as conventional DC-CARS spectroscopy at two hundred spectra per second by virtue of its high energy efficiency. Furthermore, an analysis was performed of the dependence of the SNR on the sample concentration using toluene solutions in ethanol as shown in FIG. 7(b). The SNR shows a quadratic dependence on the concentration of the sample, which can be explained by considering the CARS signal originating from the absolute square of the CARS electric field and the interference between the CARS electric field and the local oscillator. The relation between the sample concentration and SNR shows that Quasi-DC-CARS spectroscopy is effective for quantitative chemical analysis. Also, as shown in FIG. 7(c), it provides sufficient SNR at a low sample concentration of 0.4 mol/L at a spectral acquisition rate of one hundred thousand spectra per second.

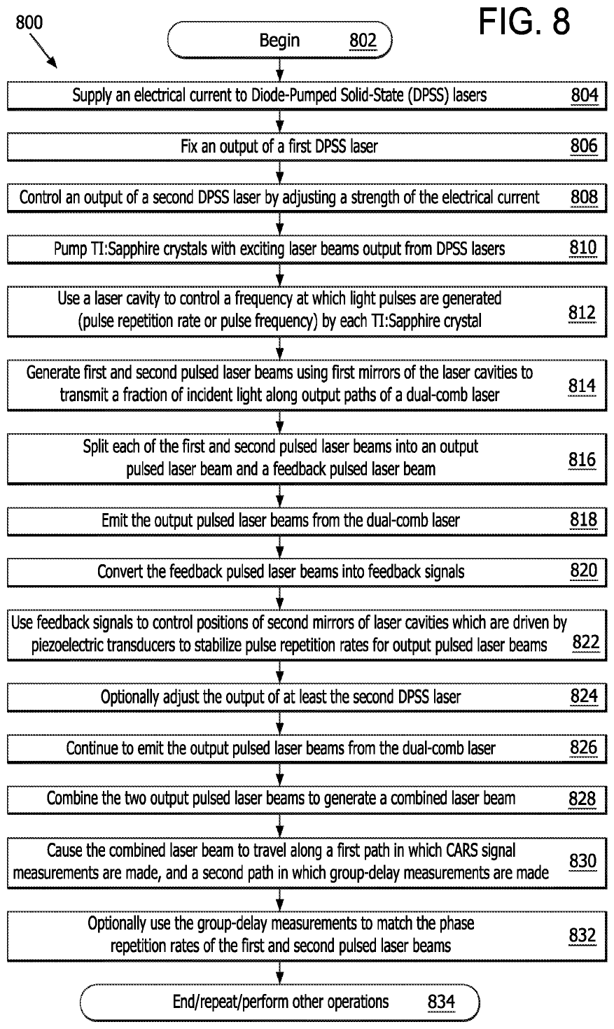

Referring now to FIG. 8, there is provided a flow diagram of an illustrative method 800 for Quasi-DC-CARS spectroscopy using a quasi-dual-comb lase as an optical source. The present solution. Method 800 provides an unprecedentedly high CARS spectral acquisition rate of one hundred thousand spectra per second with even higher sensitivity than conventional slower DC-CARS spectroscopy. With the significantly enhanced spectral acquisition rate and sensitivity, Quasi-DC-CARS spectroscopy can be used in a wide range of applications, such as in biomedical applications and material science applications.

First, video-rate imaging of living cells with vibrational fingerprints by laser-scanning Quasi-DC-CARS spectroscopy is an approach to visualizing rapid intracellular dynamics such as signaling and substance transport as well as to intraoperative diagnosis of tissues. Compared with SRS imaging in the high-frequency region (2,700-3,000 cm⁻¹) that covers CH—/OH-stretching, Raman imaging in the fingerprint region that provides much more molecular information (about ten times more biological information-rich than in the high frequency region) can help to obtain deeper insights into the mechanisms of biological functions.

Second, large-scale single-cell analysis based on coherent Raman spectroscopy is an emerging tool for characterizing the vast heterogeneity of cells and finding subpopulations of rare cells without the need for fluorescent labeling which may interfere with their functions such as metabolism. Although its application range has been limited to microorganisms (e.g., microalgae) by its low sensitivity, Quasi-DC-CARS spectroscopy paves the way for sensitive Raman flow cytometry of mammalian cells that requires a few orders of magnitude higher sensitivity than that of microorganisms.

Third, Quasi-DC-CARS spectroscopy may be useful for observing fast, non-repetitive events such as phase transition, polymerization, non-photochemical reactions, and blinking of surface-enhanced Raman scattering. In spite of their importance in basic science and industry, the underlying mechanisms of these phenomena are not well understood due to the lack of methods that can monitor them in a real-time manner. Quasi-DC-CARS spectroscopy can assist with for unveiling the mechanisms.

As shown in FIG. 8, method 800 begins with 802 and continues with 804 where an electrical current (e.g., current 448 of FIG. 4) is supplied from a function generator (e.g., function generator 416 of FIG. 4) to a DPSS laser (e.g., DPSS laser 418 of FIG. 4) of at least one laser source (e.g., laser source 302 and/or 304 of FIG. 3) of a dual-comb laser source (e.g., dual-comb laser source 306 of FIG. 3). An output intensity of the DPSS laser of a first laser source (e.g., laser source 302 of FIG. 3) is fixed in 806. In contrast, an output intensity of the DPSS laser of a second laser source (e.g., laser source 304 of FIG. 3) is controlled in 808 by adjusting a strength of the electrical current (e.g., current 448 of FIG. 4) being supplied thereto by the function generator. The output intensity of the DPSS laser is controlled to have a high intensity value or a low intensity value based on a pre-defined initial output intensity or a previously determined group-delay value (e.g., group-delay values 360 of FIG. 3). Group-delay values are well known, and techniques for determining the same are also well known.

In 810, a TI:Sapphire crystal (e.g., crystal 470 of FIG. 4) of each laser source e.g., laser sources 302, 304 of FIG. 3) is pumped with exciting laser beams output from the respective DPSS laser. At each laser source, a laser cavity (e.g., laser cavity 472 of FIG. 4) is used in 812 to control a frequency at which light pulses are generated by the TI:Sapphire crystal. The frequency at which the light pulses are generated is also referred to herein as a pulse repetition rate or pulse frequency. A pulsed laser beam (e.g., laser beam 440 of FIG. 4) is generated in 814 using a first mirror (e.g., mirror 414 of FIG. 4) of the laser cavity in each laser source. The first mirror is configured to transmit a fraction of incident light along an output path of the dual-comb laser source. The pulsed laser beam generated by the first laser source (e.g., laser source 302 of FIG. 3) is referred to herein as the first pulsed laser beam, and the pulsed laser beam generated by the second laser source (e.g., laser source 304 of FIG. 4) is referred to herein as the second pulsed laser beam. The first and second pulsed laser beams have different pulse repletion rate or pulse frequencies.

The first and second pulsed laser beams are each split into an output pulsed laser beam (e.g., pulsed laser beam 450 of FIG. 4) and a feedback pulsed laser beam (e.g., feedback pulsed laser beam 452 of FIG. 4). The output pulsed laser beams are emitted from the dual-comb laser source in 818.

In 820, each feedback pulsed laser beam is converted into a feedback signal (e.g., feedback signal 432 of FIG. 4). The feedback signals are used in 822 to control positions of second mirrors (e.g., mirror 408 of FIG. 4) of the laser cavities which are driven by piezoelectric transducers (e.g., piezoelectric transducer 406 of FIG. 4) to facilitate the stabilization of pulse repetition rates for the output pulsed laser beams.

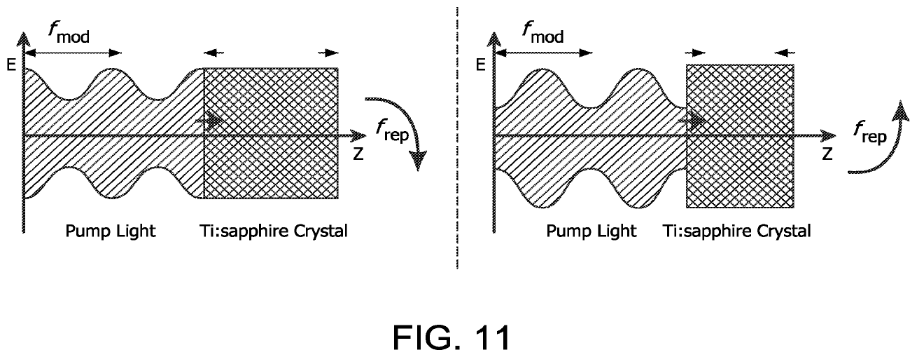

In 824, the output intensity of at least the DPSS laser of the second laser source (e.g., laser source 304 of FIG. 3) is optionally adjusted. This adjustment can involve transitioning the output intensity of the DPSS laser from a high intensity value to a low intensity value, or vice versa. This intensity adjustment can be performed to facilitate a rapid modulation of a difference between the pulse repetition rates of the first and second laser sources (e.g., laser sources 302 and 304 of FIG. 3). Graphs are provided in FIG. 11 which is useful for understanding that the pulse repetition rate modulation can be achieved by controlling the intensity of the DPSS laser of at least the second laser source.

The dual-comb laser source continues to emit the two output pulsed laser beams as shown by 826. The two output pulsed laser beams are combined with each other in 828 to generate a combined laser beam. In 830, the combined laser beam is caused to travel along a first path (e.g., the path defined by branch 310 of FIG. 3) in which CARS signal measurements are made, and a second path (e.g., the path defined by branch 312 of FIG. 3) in which group-delay measurements are made by two-color interferometry. CARS signal measurements and group-delay measurements are well known, and techniques for determining the same are well known. The group-delay measurements are optionally used in 832 to match the phase repetition rates of the first and second pulsed laser beams and/or for calibrating a phase of each Rama active mode in a sample (e.g., sample 320 of FIG. 3) of the first path. Subsequently, 834 is performed where method 800 ends, at least a portion of method 800 is repeated, or other operations are performed.

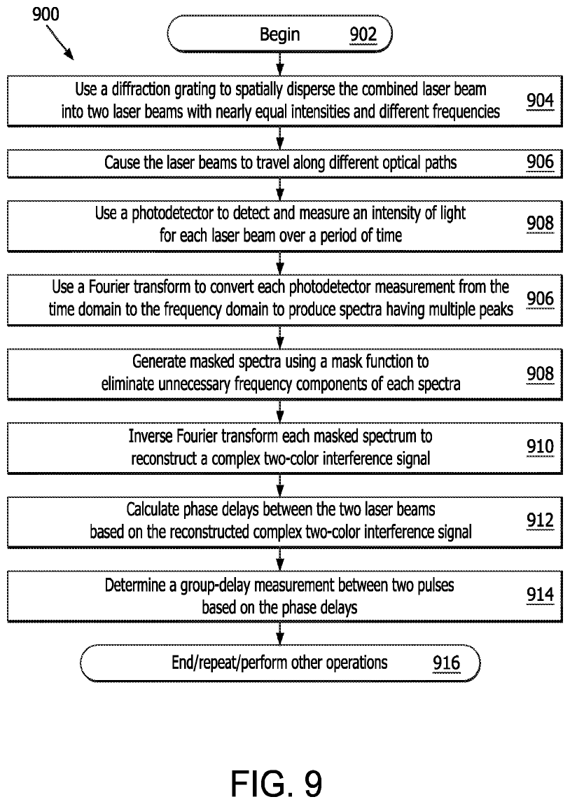

Referring now to FIG. 9, there is provided a flow diagram of an illustrative method 900 for determining group-delay measurements or values based on TCIs. Method 900 can be performed in block 830 of FIG. 8 to make group-delay measurements.

Method 900 begins with 902 and continues with 904 where a diffraction grating (e.g., diffraction grating 328 of FIG. 3) is used to spatially disperse the combined laser beam into two laser beams (e.g., laser beams 330, 332 of FIG. 3) with nearly equal intensities and different frequencies. The laser beams are caused to travel along different optical paths as shown by 906. In 908, a photodetector (e.g., photodetector 336 or 338 of FIG. 3) is used to detect and measure an intensity of light for each laser beam over a period of time. A Fourier transform is used in 906 to convert each photodetector measurement from the time domain to the frequency domain to produce spectra having multiple peaks. Masked spectra are generated in 908 using a mask function to eliminate unnecessary frequency components of each spectra. An inverse Fourier transform of each masked spectrum is generated to reconstruct a complex two-color interference signal, as shown by 910. In 912, phase delays are calculated between the two laser beams based on the reconstructed complex two-color interference signal. Such phase delay calculations are well known. A group-delay measurement is determined between two pulses based on the phase delays. Such group-delay measurement determinations are well known. Subsequently, 916 is performed where method 900 ends, at least a portion of method 900 is repeated, or other operations are performed.

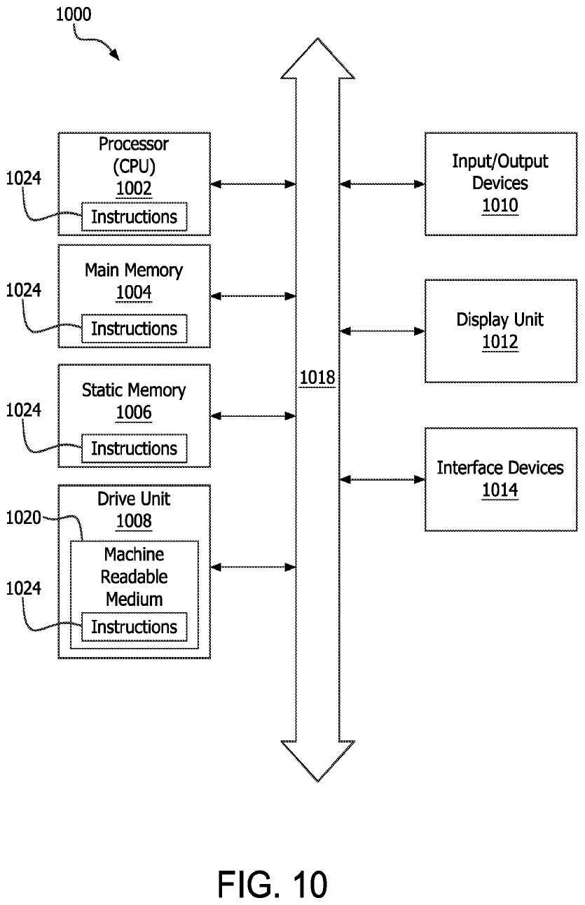

Referring now to FIG. 10, there is shown a hardware block diagram comprising an illustrative computer system 1000 that can be used for implementing all or part of components 340 of FIGS. 3 and/or 402, 416, 428 of FIG. 4. The machine can include a set of instructions which are used to cause the circuit/computer system to perform any one or more of the methodologies discussed herein. While only a single machine is illustrated in FIG. 10, it should be understood that in other scenarios the system can be taken to involve any collection of machines that individually or jointly execute one or more sets of instructions as described herein.

The computer system 1000 is comprised of a processor 1002 (e.g., a Central Processing Unit (CPU)), a main memory 1004, a static memory 1006, a drive unit 1008 for mass data storage and comprised of machine readable media 1020, input/output devices 1010, a display unit 1012 (e.g., a Liquid Crystal Display (LCD)) or a solid state display, and one or more interface devices 1014. Communications among these various components can be facilitated by means of a data bus 1018. One or more sets of instructions 1024 can be stored completely or partially in one or more of the main memories 1004, static memory 1006, and drive unit 1008. The instructions can also reside within the processor 1002 during execution thereof by the computer system. The input/output devices 1010 can include a keyboard, a multi-touch surface (e.g., a touchscreen) and so on. The interface device(s) 1014 can be comprised of hardware components and software or firmware to facilitate an interface to external circuitry. For example, in some scenarios, the interface devices 1014 can include one or more Analog-to-Digital (A/D) converters, Digital-to-Analog (D/A) converters, input voltage buffers, output voltage buffers, voltage drivers and/or comparators. These components are wired to allow the computer system to interpret signal inputs received from external circuitry and generate the necessary control signals for certain operations described herein.

The drive unit 1008 can comprise a machine readable medium 1020 on which is stored one or more sets of instructions 1024 (e.g. software) which are used to facilitate one or more of the methodologies and functions described herein. The term “machine-readable medium” shall be understood to include any tangible medium that is capable of storing instructions or data structures which facilitate any one or more of the methodologies of the present disclosure. Exemplary machine-readable media can include solid-state memories, Electrically Erasable Programmable Read-Only Memory (EEPROM) and flash memory devices. A tangible medium as described herein is one that is non-transitory insofar as it does not involve a propagating signal.

Computer system 1000 should be understood to be one possible example of a computer system which can be used in connection with the various implementations disclosed herein. However, the systems and methods disclosed herein are not limited in this regard and any other suitable computer system architecture can also be used without limitation. Dedicated hardware implementations including, but not limited to, application-specific integrated circuits, programmable logic arrays, and other hardware devices can likewise be constructed to implement the methods described herein. Applications that can include the apparatus and systems broadly include a variety of electronic and computer systems. Thus, the exemplary system is applicable to software, firmware, and hardware implementations.

Further, it should be understood that embodiments can take the form of a computer program product on a tangible computer-usable storage medium (for example, a hard disk or a CD-ROM). The computer-usable storage medium can have computer-usable program code embodied in the medium. The term computer program product, as used herein, refers to a device comprised of all the features enabling the implementation of the methods described herein. Computer program, software application, computer software routine, and/or other variants of these terms, in the present context, mean any expression, in any language, code, or notation, of a set of instructions intended to cause a system having an information processing capability to perform a particular function either directly or after either or both of the following: a) conversion to another language, code, or notation; or b) reproduction in a different material form.

The described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

We claim:

1. A method for operating a dual-comb laser, comprising:
generating pulsed laser beams by first and second laser sources of the dual-comb laser, at least one of the first and second laser sources comprises a diode pumped solid state laser with an output intensity that is modifiable; and
matching phase repetition rates of the pulsed laser beams by selectively modifying the output intensity of the diode pumped solid state laser.

2. The method according to claim 1, wherein the first laser source comprises a diode pumped solid state laser with a fixed output intensity, and the second laser source comprises the diode pumped solid state laser with the output intensity that is modifiable.

3. The method according to claim 1, wherein the output intensity of the diode pumped solid state laser is selectively modified based on a group-delay value determined using two-color interferometry.

4. The method according to claim 1, wherein the output intensity of the diode pumped solid state laser is selectively modified by transitioning the diode pumped solid state laser from a first output intensity level to a second different output intensity level.

5. The method according to claim 1, wherein the output intensity of the diode pumped solid state laser is selectively modified by changing an electrical current supplied to the diode pumped solid state laser.

6. The method according to claim 5, wherein the electrical current is changed responsive to a group-delay value determined using two-color interferometry.

7. The method according to claim 1, wherein the selective modification of the output intensity of the diode pumped solid state laser causes a refractive index of a crystal to be changed, whereby the pulse repetition rates are matched.

8. The method according to claim 1, further comprising:
generating a feedback signal using one of the pulsed laser beams;
using the feedback signal to control a position of mirror in a laser cavity of the first or second laser sources which is driven by a piezoelectric transducer.

9. The method according to claim 1, further comprising rapidly modulating a difference between the phase repetition rates of the first and second laser sources.

10. A method for operating a laser source, comprising:
generating a pulsed laser beam using a crystal pumped by an exciting laser beam output from a diode pumped solid state laser; and
selectively changing an intensity of the exciting laser beam to cause a refractive index of the crystal to change.

11. The method according to claim 10, wherein the intensity of the exciting laser beam is selectively changed based on a group-delay value determined using two-color interferometry.

12. The method according to claim 10, wherein the intensity of the exciting laser beam is selectively changed by adjusting an electrical current supplied to the diode pumped solid state laser.

13. The method according to claim 12, wherein the electrical current is adjusted based on a group-delay value determined using two-color interferometry.

14. A dual-comb laser, comprising:
first and second laser sources configured to generate pulsed laser beams, at least one of the first and second laser sources comprises a diode pumped solid state laser with an output intensity that is modifiable; and
a circuit configured to selectively modify the output intensity of the diode pumped solid state laser for matching phase repetition rates of the pulsed laser beams.

15. The dual-comb laser according to claim 14, wherein the first laser source comprises a diode pumped solid state laser with a fixed output intensity, and the second laser source comprise the diode pumped solid state laser with the output intensity that is modifiable.

16. The dual-comb laser according to claim 14, wherein the output intensity of the diode pumped solid state laser is selectively modified based on a group-delay value determined using two-color interferometry.

17. The dual-comb laser according to claim 14, wherein the output intensity of the diode pumped solid state laser is selectively modified by transitioning the diode pumped solid state laser from a first output intensity level to a second different output intensity level.

18. The dual-comb laser according to claim 14, wherein the output intensity of the diode pumped solid state laser is selectively modified by changing an electrical current supplied to the diode pumped solid state laser.

19. The dual-comb laser according to claim 18, wherein the electrical current is changed responsive to a group-delay value determined using two-color interferometry.

20. The dual-comb laser according to claim 14, further comprising a crystal having a refractive index that changes when the output intensity of the diode pumped solid state laser is modified, whereby the pulse repetition rates become matched.

21. The dual-comb laser according to claim 14, wherein the circuit is further configured to (i) generate a feedback signal using one of the pulsed laser beams and (ii) use the feedback signal to control a position of mirror in a laser cavity of the first or second laser sources which is driven by a piezoelectric transducer.

22. A laser source, comprising:
a diode pumped solid state laser;
a crystal configured to generate a pulsed laser beam when pumped by an exciting laser beam output from the diode pumped solid state laser; and
a circuit configured to selectively change an intensity of the exciting laser beam to cause a refractive index of the crystal to change.

23. The laser source according to claim 22, wherein the intensity of the exciting laser beam is selectively changed based on a group-delay value determined using two-color interferometry.

24. The laser source according to claim 22, wherein the intensity of the exciting laser beam is selectively changed by adjusting an electrical current supplied to the diode pumped solid state laser.

25. The laser source according to claim 24, wherein the electrical current is adjusted based on a group-delay value determined using two-color interferometry.
